(19) United States
(12) Patent Application Publication
(10) Pub. No.: US 2007/0273484 A1
(43) Pub. Date: Nov. 29, 2007

(54) Method of and reader for automatic synchronization of reader wakeup signals to radio tags

(76) Inventors: Magnus Cederlof, Sollentuna (SE); Stig Ekstrom, Jarfalla (SE)

Correspondence Address: GENERAL ELECTRIC CO.;GLOBAL PATENT OPERATION, 187 Danbury Road, Suite 204, Wilton, CT, 06897-4122, US

(21) Appl. No.: 11/432,185

(22) Filed: May 11, 2006

(51) Int. Cl. H04Q 5/22

(52) U.S. Cl. 340/10.33; 340/825.2; 340/10.2; 370/311

(57) ABSTRACT

A method for synchronizing wakeup signals transmitted by a plurality of readers to at least one radio tag includes monitoring, by a first reader, for a first wakeup signal transmitted by a second reader. If the first wakeup signal is detected by the first reader, the first reader transmits a second wakeup signal having a duration ending at substantially the same time as the first wakeup signal. If the first wakeup signal is not detected by the first reader, the first reader transmits a third wakeup signal having a default duration. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims. 37 CFR 1.72(b).

### BACKGROUND OF THE INVENTION

1. Technical Field

The present invention relates to a method of and system for monitoring the security of a container and tracking its location and, more particularly, but not by way of limitation, to a method of and system for synchronizing wakeup signals transmitted from readers to radio tags used for monitoring the security of and tracking intermodal freight containers throughout a supply chain to discourage or prevent such urgent problems as terrorism, and also illegal immigration, theft or adulteration of goods, and other irregularities.

2. History of Related Art

The vast majority of goods shipped throughout the world are shipped via what are referred to as intermodal freight containers. As used herein, the term “containers” includes any container (whether with wheels attached or not) that is not transparent to radio frequency signals, including, but not limited to, intermodal freight containers. The most common intermodal freight containers are known as International Standards Organization (ISO) dry intermodal containers, meaning they meet certain specific dimensional, mechanical and other standards issued by the ISO to facilitate global trade by encouraging development and use of compatible standardized containers, handling equipment, ocean-going vessels, railroad equipment and over-the-road equipment throughout the world for all modes of surface transportation of goods. There are currently more than 12 million such containers in active circulation around the world as well as many more specialized containers such as refrigerated containers that carry perishable commodities. The United States alone receives approximately six million loaded containers per year, or approximately 17,000 per day, representing nearly half of the total value of all goods received each year.

Since approximately 90% of all goods shipped internationally are moved in containers, container transport has become the backbone of the world economy. The sheer volume of containers transported worldwide renders individual physical inspection impracticable, and only approximately 2% to 3% of containers entering the United States are actually physically inspected. Risk of introduction of a terrorist biological, radiological or explosive device via a freight container is high, and the consequences to the international economy of such an event could be catastrophic, given the importance of containers in world commerce.

Even if sufficient resources were devoted in an effort to conduct physical inspections of all containers, such an undertaking would result in serious economic consequences. The time delay alone could, for example, cause the shutdown of factories and undesirable and expensive delays in shipments of goods to customers.

Current container designs fail to provide adequate mechanisms for establishing and monitoring the security of the containers or their contents. A typical container includes one or more door hasp mechanisms that allow for the insertion of a plastic or metal indicative “seal” or bolt barrier conventional “seal” to secure the doors of the container. The door hasp mechanisms that are conventionally used are very easy to defeat, for example, by drilling an attachment bolt of the hasp out of a door to which the hasp is attached. The conventional seals themselves currently in use are also quite simple to defeat by use of a common cutting tool and replacement with a rather easily duplicated seal.

A more advanced solution proposed in recent times is an electronic seal (“e-seal”). These e-seals are equivalent to traditional door seals and are applied to the containers via the same, albeit weak, door hasp mechanism as an accessory to the container, but include an electronic device such as a radio or radio reflective device that can transmit the e-seal's serial number and a signal if the e-seal is cut or broken after it is installed. However, the e-seal is not able to communicate with the interior or contents of the container and does not transmit information related to the interior or contents of the container to another device.

The e-seals typically employ either low-power radio transceivers or use radio frequency backscatter techniques to convey information from an e-seal tag to a reader installed at, for example, a terminal gate. Radio frequency backscatter involves use of a relatively expensive, narrow-band high-power radio technology based on combined radar and radio-broadcast technology. Radio backscatter technologies require that a reader send a radio signal with relatively high transmitter power (i.e., 0.5-3 W) that is reflected or scattered back to the reader with modulated or encoded data from the e-seal.

In addition, e-seal applications currently use completely open, unencrypted and insecure air interfaces and protocols allowing for relatively easy hacking and counterfeiting of e-seals. Current e-seals also operate only on locally authorized frequency bands below 1 GHz, rendering them impractical to implement in global commerce involving intermodal containers since national radio regulations around the world currently do not allow their use in many countries.

Furthermore, the e-seals are not effective at monitoring security of the containers from the standpoint of alternative forms of intrusion or concern about the contents of a container, since a container may be breached or pose a hazard in a variety of ways since the only conventional means of accessing the inside of the container is through the doors of the container. For example, a biological agent could be implanted in the container through the container's standard air vents, or the side walls of the container could be cut through to provide access. Although conventional seals and the e-seals afford one form of security monitoring the door of the container, both are susceptible to damage. The conventional seal and e-seals typically merely hang on the door hasp of the container, where they are exposed to physical damage during container handling such as ship loading and unloading. Moreover, conventional seals and e-seals cannot monitor the contents of the container.

The utilization of multiple sensors for monitoring the interior of a container could be necessary to cover the myriad of possible problems and/or threatening conditions. For example, the container could be used to ship dangerous, radioactive materials, such as a bomb. In that scenario, a radiation sensor would be needed in order to detect the presence of such a serious threat. Unfortunately, terrorist menaces are not limited to a single category of threat. Both chemical and biological warfare have been used and pose serious threats to the public at large. For this reason, both types of detectors could be necessary, and in certain situations, radiation, gas and biological sensors could be deemed appropriate. One problem with the utilization of such sensors is, however, the transmission of such sensed data to the outside world when the sensors are placed in the interior of the container. Since standard intermodal containers are manufactured from steel that is opaque to radio signals, it is virtually impossible to have a reliable system for transmitting data from sensors placed entirely within such a container unless the data transmission is addressed. If data can be effectively transmitted from sensors disposed entirely within an intermodal container, conditions such as temperature, light, combustible gas, motion, radio activity, biological and other conditions and/or safety parameters can be monitored. Moreover, the integrity of the mounting of such sensors are critical and require a more sophisticated monitoring system than the aforementioned door hasp mechanisms that allow for the insertion of a plastic or metal indicative “seal” or bolt barrier conventional “seal” to secure the doors of the container.

In addition to the above, the monitoring of the integrity of containers via door movement can be relatively complex. Although the containers are constructed to be structurally sound and carry heavy loads, both within the individual containers as well as by virtue of containers stacked upon one another, each container is also designed to accommodate transverse loading to accommodate dynamic stresses and movement inherent in (especially) ocean transportation and which are typically encountered during shipment of the container. Current ISO standards for a typical container may allow movement on a vertical axis due to transversal loads by as much as 40 millimeters relative to one another. Therefore, security approaches based upon maintaining a tight interrelationship between the physical interface between two container doors are generally not practicable.

### SUMMARY OF THE INVENTION

One embodiment of the invention is directed to a method for synchronizing wakeup signals transmitted by a plurality of readers to at least one radio tag. The method includes monitoring, by a first reader, for a first wakeup signal transmitted by a second reader. If the first wakeup signal is detected by the first reader, the first reader transmits a second wakeup signal having a duration ending at substantially the same time as the first wakeup signal. In a further embodiment, if the first wakeup signal is not detected by the first reader, the first reader transmits a third wakeup signal having a default duration.

Another embodiment of the invention is directed to a first reader for transmitting at least one wakeup signal to at least one radio tag. The first reader includes at least one computer readable medium, and processor instructions contained on the at least one computer readable medium. The processor instructions are configured to be readable from the at least one computer readable medium by at least one processor and thereby cause the at least one processor to operate as to monitor for a first wakeup signal transmitted by a second reader; and if the first wakeup signal is detected, transmit a second wakeup signal having a duration ending at substantially the same time as the first wakeup signal. In a further embodiment, the processor instructions are further configured to cause the at least one processor to operate as to transmit a third wakeup signal having a default duration if the first wakeup signal is not detected by the first reader.

The above summary of the invention is not intended to represent each embodiment or every aspect of the present invention.

### BRIEF DESCRIPTION OF THE DRAWINGS

FIG. 1A is a diagram illustrating communication among components of a system in accordance with principles of the present invention;

FIG. 1B is a diagram illustrating an exemplary supply chain;

FIG. 2 is a schematic diagram of a radio tag in accordance with principles of the present invention;

FIG. 3A is a schematic diagram of a reader in accordance with principles of the present invention;

FIG. 3B is a diagram of a reader in accordance with principles of the present invention;

FIG. 4 is a first application scenario of the system of FIG. 1A in accordance with principles of the present invention;

FIG. 5 is a second application scenario of the system of FIG. 1A in accordance with principles of the present invention;

FIG. 6 is a third application scenario of the system of FIG. 1A in accordance with principles of the present invention;

FIG. 7 is a fourth application scenario of the system of FIG. 1A in accordance with principles of the present invention;

FIG. 8 is a diagram illustrating a container-securing process in accordance with principles of the present invention;

FIG. 9 is a diagram illustrating a container-security-check process in accordance with principles of the present invention;

FIG. 10 illustrates a system without synchronization of wakeup signals between readers;

FIG. 11A illustrates a diagram showing operation of a system with synchronization of wakeup signals between readers in accordance with principles of the present invention;

FIG. 11B illustrates another diagram showing operation of a system with synchronization of wakeup signals between readers in accordance with principles of the present invention;

FIG. 12 illustrates a process for synchronizing the wake-up signals of a Reader with those of another Reader in accordance with principles of the present invention;

FIGS. 13A-13B illustrates a data format for exchanging messages between a reader and an radio tag in accordance with principles of the present invention; and

FIG. 14 illustrates a data format for a wakeup frame in accordance with principles of the present invention.

A more complete understanding of the method and apparatus of the present invention may be obtained by reference to the following Detailed Description when taken in conjunction with the accompanying Drawings wherein:

### DETAILED DESCRIPTION OF ILLUSTRATIVE EMBODIMENTS OF THE INVENTION

Various embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

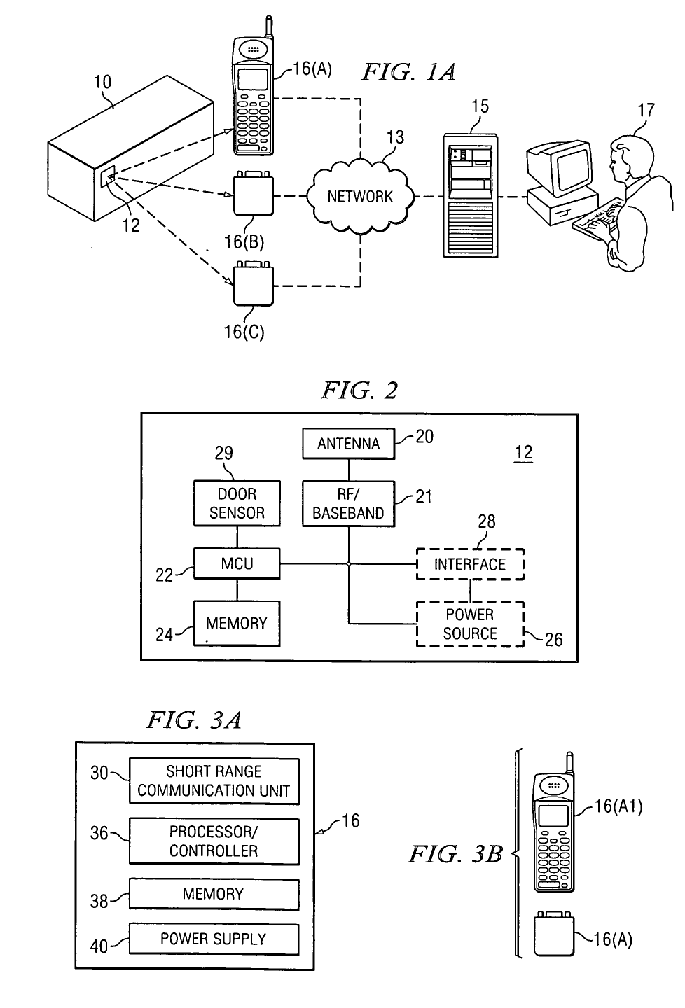

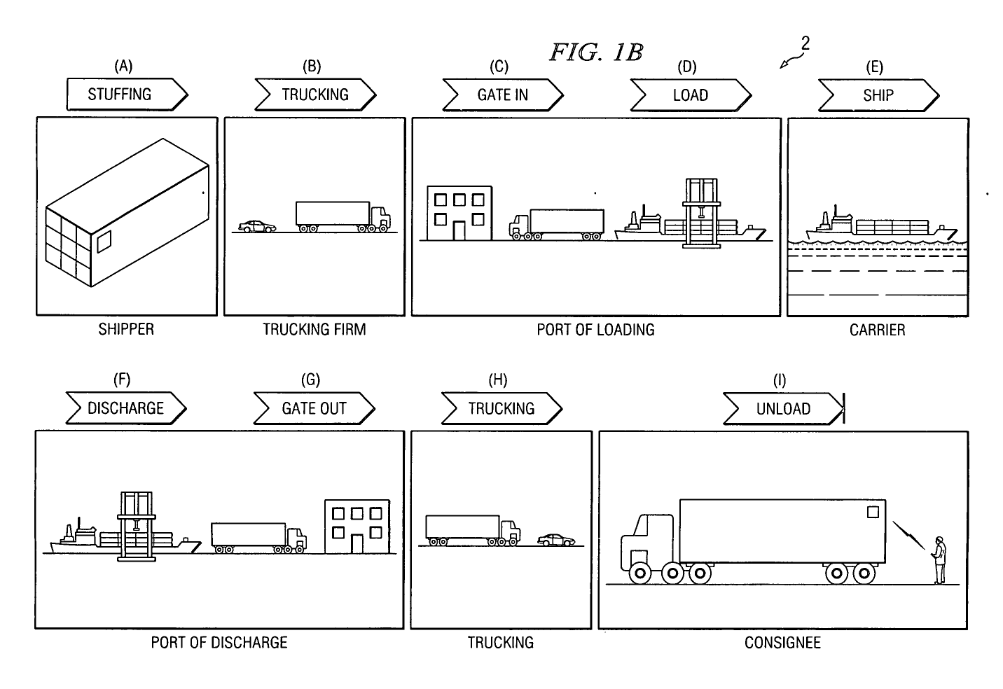

FIG. 1A is a diagram illustrating communication among components of a system in accordance with principles of the present invention. The system includes a radio tag 12, at least one variety of reader 16, a server 15, and a software backbone 17. The radio tag 12 ensures that a container 10 has not been breached after the container 10 has been secured. The container 10 is secured and tracked by a reader 16. Each reader 16 may include hardware or software for communicating with the server 15 such as a modem for transmitting data over GSM, CDMA, etc. or a cable for downloading data to a PC that transmits the data over the Internet to the server 15. Various conventional means for transmitting the data from the reader 16 to the server 15 may be implemented within the reader 16 or as a separate device. The reader 16 may be configured as a handheld reader 16(A), a mobile reader 16(B), or a fixed reader 16(C). The handheld reader 16(A) may be, for example, operated in conjunction with, for example, a mobile phone, a personal digital assistant, or a laptop computer. The mobile reader 16(B) is basically a fixed reader with a GPS interface, typically utilized in mobile installations (e.g., on trucks, trains, or ships using existing GPS, AIS or similar positioning systems) to secure, track, and determine the integrity of the container in a manner similar to that of the hand-held reader 16(A). In fixed installations, such as, for example, those of a port or shipping yard, the fixed reader 16(C) is typically installed on a crane or gate. The reader 16 serves primarily as a relay station between the radio tag 12 and the server 15.

The server 15 stores a record of security transaction details such as, for example, door events (e.g., security breaches, container security checks, securing the container, and disarming the container), location, as well as any additional desired peripheral sensor information (e.g., temperature, motion, radioactivity). The server 15, in conjunction with the software backbone 17, may be accessible to authorized parties in order to determine a last known location of the container 10, make integrity inquiries for any number of containers, or perform other administrative activities.

The radio tag 12 communicates with the readers 16 via a short-range radio interface such as, for example, a radio interface utilizing direct-sequence spread-spectrum principles. The radio interface may use, for example, BLUETOOTH or any other short-range, low-power radio system that operates in the license-free Industrial, Scientific, and Medical (ISM) band, which operates around e.g. 2.4 GHz. Depending on the needs of a specific solution, related radio ranges are provided, such as, for example, a radio range of up to 100 m.

The readers 16 may communicate via a network 13, e.g. using TCP/IP, with the server 15 via any suitable technology such as, for example, Universal Mobile Telecommunications System (UMTS), Global System for Mobile Communications (GSM), Code Division Multiple Access (CDMA), Time Division Multiple Access (TDMA), Pacific Digital Cellular System (PDC), Wideband Local Area Network (WLAN), Local Area Network (LAN), Satellite Communications systems, Automatic Identification Systems (AIS), or Mobitex. The server 15 may communicate with the software backbone 17 via any suitable wired or wireless technology. The software backbone 17 is adapted to support real-time surveillance services such as, for example, tracking and securing of the container 10 via the server 15, the readers 16, and the radio tag 12. The server 15 and/or the software backbone 17 are adapted to store information such as, for example, identification information, tracking information, door events, and other data transmitted by the radio tag 12 and by any additional peripheral sensors interoperably connected to the radio tag 12. The software backbone 17 also allows access for authorized parties to the stored information via a user interface that may be accessed via, for example, the Internet. In order to conserve power, the radio tag 12 may operate in a power-conservation mode until a wakeup signal is received from one or more of the readers 16. Upon reception of a wakeup signal, the radio tag 12 switches to an active mode in which it can transmit information to the reader 16.

Referring now to FIG. 1B, there is shown a diagram illustrating a flow 2 of an exemplary supply chain from points (A) to (I). Referring first to point (A), a container 10 is filled with cargo by a shipper or the like. At point (B), the loaded container is shipped to a port of embarkation via highway or rail transportation. At point (C), the container is gated in at the port of loading such as a marine shipping yard.

At point (D), the container is loaded on a ship operated by a carrier. At point (E), the container is shipped by the carrier to a port of discharge. At point (F), the container is discharged from the ship. Following discharge at point (F), the container is loaded onto a truck and gated out of the port of discharge at point (G). At point (H), the container is shipped via land to a desired location in a similar fashion to point (B). At point (I), upon arrival at the desired location, the container is unloaded by a consignee.

As will be apparent to those having ordinary skill in the art, there are many times within the points of the flow 2 at which security of the container could be compromised without visual or other conventional detection. In addition, the condition of the contents of the container could be completely unknown to any of the parties involved in the flow 2 until point (H) when the contents of the container are unloaded.

FIG. 2 is a block diagram of a radio tag 12 in accordance with principles of the present invention. The radio tag 12 includes an antenna 20, an RF/baseband unit 21 including a transmitter and receiver, a microprocessor (MCU) 22, a memory 24, and a door sensor 29. The radio tag 12 may also include an interface 28 for attachment of additional sensors to monitor various internal conditions of the container such as, for example, temperature, vibration, radioactivity, gas detection, and motion. The radio tag 12 may also include an optional power source 26 (e.g., battery); however, other power arrangements that are detachable or remotely located may also be utilized by the radio tag 12. When the power source 26 includes a battery (as shown herein), inclusion of the power source 26 in the radio tag 12 may help to prolong battery life by subjecting the power source 26 to smaller temperature fluctuations by virtue of the power source 26 being inside the container 10. The presence of the power source 26 within the container 10 is advantageous in that the ability to tamper with or damage the power source 26 is decreased. The radio tag 12 may also optionally include a connector for interfacing directly with the reader 16. For example, a connector may be located on an outer wall of the container 10 for access by the reader 16. The reader 16 may then connect via a cable or other direct interface to download information from the radio tag 12.

The microprocessor 22 (equipped with an internal memory) discerns door events from the door sensor 29, including, for example, container-security requests, container-disarming requests, and container-security checks. The discerned door events also include security breaches that may compromise the contents of the container 10, such as opening of a door after the container 10 has been secured. The door events may be time-stamped and stored in the memory 24 for transmission to the reader 16. The door events may be transmitted immediately, periodically, or in response to an interrogation from the reader 16. The door sensor 29 shown herein is of the pressure sensitive variety, although it may be, for example, an alternative contact sensor, a proximity sensor, or any other suitable type of sensor detecting relative movement between two surfaces. The term pressure sensor as used herein thus includes, but is not limited to, these other sensor varieties.

The antenna 20 is provided for data exchange with the reader 16. In particular, various information, such as, for example, status and control data, may be exchanged. The microprocessor 22 may be programmed with a code that uniquely identifies the container 10. The code may be, for example, an International Standards Organization (ISO) container identification code. The microprocessor 22 may also store other logistic data, such as Bill-of-Lading (B/L), a mechanical seal number, a reader identification with a time-stamp, etc. A special log file may be generated, so that tracking history together with door events may be recovered. The code may also be transmitted from the radio tag 12 to the reader 16 for identification purposes. The RF/baseband unit 21 upconverts microprocessor signals from baseband to RF for transmission to the reader 16.

The radio tag 12 may, via the antenna 20, receive an integrity inquiry from the reader 16. In response to the integrity query, the microprocessor 22 may then access the memory to extract, for example, door events, temperature readings, security breaches, or other stored information in order to forward the extracted information to the reader 16. The reader 16 may also send a security or disarming request to the radio tag 12. When the container 10 is secured by the reader 16, the MCU 22 of the radio tag 12 may be programmed to emit an audible or visual alarm when the door sensor 29 detects a material change in pressure after the container is secured. The radio tag 12 may also log the breach of security in the memory 24 for transmission to the reader 16. If the reader 16 sends a disarming request to the radio tag 12, the microprocessor 22 may be programmed to disengage from logging door events or receiving signals from the door sensor 29 or other sensors interoperably connected to the radio tag 12.

The microprocessor 22 may also be programmed to implement power-management techniques for the power source 26 to avoid any unnecessary power consumption. In particular, one option is that one or more time window(s) are specified via the antenna 20 for activation of the components in the radio tag 12 to exchange data. Outside the specified time windows, the radio tag 12 may be set into a sleep mode to avoid unnecessary power losses. Such a sleep mode may account for a significant part of the device operation time, the radio tag 12 may as a result be operated over several years without a need for battery replacement.

In particular, according to principles of the present invention, the radio tag 12 utilizes a “sleep” mode to achieve economic usage of the power source 26. In the sleep mode, a portion of the circuitry of the radio tag 12 is switched off. For example, all circuitry may be switched off except for the door sensor 29, the receiver circuitry, and portions of the microprocessor 22. In a typical embodiment, when the radio tag 12 receives a wake-up signal, the remaining circuitry of the radio tag 12 is powered up. After the radio tag 12 receives the wakeup signal from the reader 16, the radio tag 12 remains in an active mode to communicate with the reader 16 as long as required. In a typical embodiment, the radio tag 12 may return to the “sleep” mode after a predetermined period of time has elapsed without receiving a signal from the reader 16. In a typical embodiment, the reader-signal time period is much shorter (e.g., by several orders of magnitude less) than the sleep time period so that the lifetime of the device is prolonged accordingly (e.g., by several orders of magnitude) relative to an “always on” scenario.

While the above-described power-management method has been explained with respect to the radio tag 12 in the context of shipment of freight containers or other cargo in transportation by sea, road, rail or air, it should be understood by those skilled in the art that the above-described power-management method may as well be applied to, for example, shipment of animals, identification of vehicles for road toll collection, and theft protection, as well as stock management and supply-chain management.

As shown in FIG. 3A, the reader 16 includes a short range communication unit 30, a microprocessor/controller 36, a memory 38, and a power supply 40. The short range communication unit 30 achieves the wireless short-range, low-power communication link to the radio tag 12 as described above with reference to FIG. 2A. The reader 16 may include or separately attach to a device that achieves a link to a remote container-surveillance system (e.g., according to GSM, CDMA, PDC, or DAMPS wireless communication standard or using a wired LAN or a wireless local area network WLAN, Mobitex, GPRS, UMTS). Those skilled in the art will understand that any such standard is non-binding for the present invention and that additional available wireless communications standards may as well be applied to the long range wireless communications of the reader 16. Examples include satellite data communication standards like Inmarsat, Iridium, Project 21, Odyssey, Globalstar, ECCO, Ellipso, Tritium, Teledesic, Spaceway, Orbcom, Obsidian, ACeS, Thuraya, or Aries in cases where terrestrial mobile communication systems are not available.

The reader 16 may include or attach to a satellite positioning unit 34 is for positioning of a vehicle on which the container 10 is loaded. For example, the reader 16 may be the mobile reader 16(B) attached to a truck, ship, or railway car. The provision of the positioning unit 34 is optional and may be omitted in case tracking and positioning of the container 10 is not necessary. For instance, the location of the fixed reader 16(C) may be known; therefore, the satellite positioning information would not be needed. One approach to positioning could be the use of satellite positioning systems (e.g., GPS, GNSS, or GLONASS). Another approach could be the positioning of the reader 16 utilizing a mobile communication network. Here, some of the positioning techniques are purely mobile communication network based (e.g., EOTD) and others rely on a combination of satellite and mobile communication network based positioning techniques (e.g., Assisted GPS).

The microprocessor 36 and the memory 38 in the reader 16 allow for control of data exchanges between the reader 16 and the radio tag 12 as well as a remote surveillance system as explained above and also for a storage of such exchanged data. Necessary power for the operation of the components of the reader 16 is provided through a power supply 40.

FIG. 3B is a diagram of a handheld reader 16(A) in accordance with principles of the present invention. The handheld reader 16(A) is shown detached from a mobile phone 16(A1). The handheld reader 16(A) communicates (as previously mentioned) with the radio tag 12 via, for example, a short-range direct sequence spread spectrum radio interface. Once the handheld reader 16(A) and the radio tag 12 are within close range of one another (e.g., <100 m), the radio tag 12 and the handheld reader 16(A) may communicate with one another. The handheld reader 16(A) may be used to electronically secure or disarm the container via communication with the radio tag 12. The handheld reader 16(A) may also be used to obtain additional information from the radio tag 12 such as, for example, information from additional sensors inside the container 10 or readings from the door sensor 29.

The handheld reader 16(A) shown in FIG. 3B is adapted to be interfaced with a mobile phone shown as 16(A1) or PDA. However, as will be appreciated by those having skill in the art, the handheld reader 16(A) may be a standalone unit or may also be adapted to be interfaced with, for example, a personal digital assistant or a handheld or laptop computer. The reader 16 draws power from the mobile phone and utilizes Bluetooth, or any similar interface, to communicate with the mobile phone.

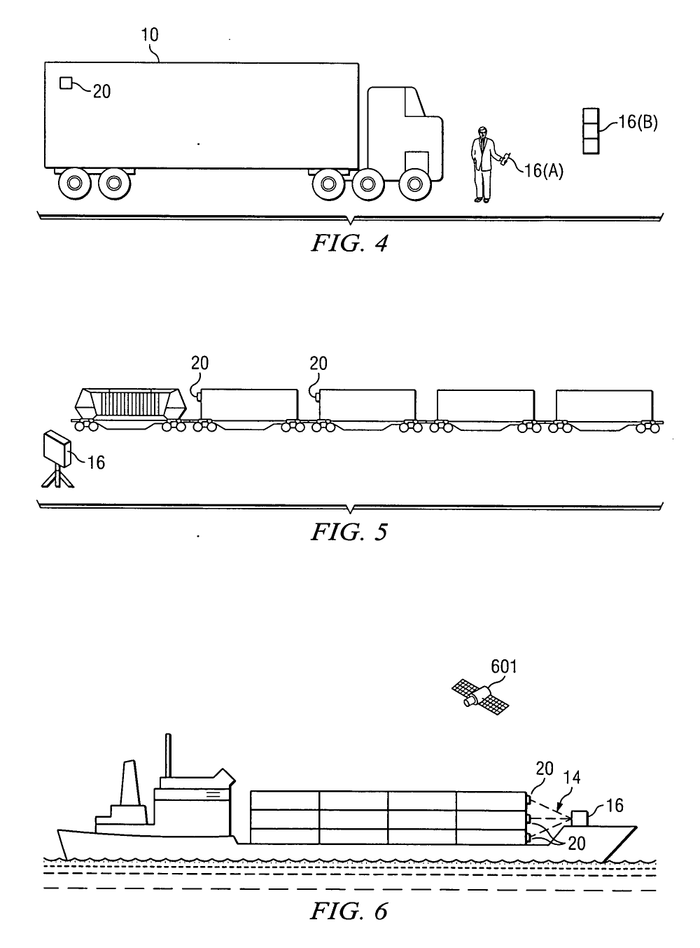

Additional application scenarios for the application of the radio tag 12 and reader 16 will now be described with respect to FIGS. 4-8. Insofar as the attachment and detachment of the reader 16(B) to different transporting or transported units is referred to, any resolvable attachment is well covered by the present invention (e.g., magnetic fixing, mechanic fixing by screws, rails, hooks, balls, snap-on mountings, further any kind of electrically achievable attachment, e.g., electro magnets, or further reversible chemical fixtures such as adhesive tape, scotch tape, glue, pasted tape).

FIG. 4 shows a first application scenario of the radio tag 12 and the reader 16. As shown in FIG. 4 one option related to road transportation is to fix the reader 16 to the gate or a shipping warehouse or anywhere along the supply chain. In such a case, the reader 16 may easily communicate with the radio tag 12 of the container 10 when being towed by the truck when exiting the shipping area. Another option is to provide the reader 16 as a handheld reader 16(A) as described above and then either scan the radio tag 12 as the truck leaves the area or carry the hand-held reader 16(A) within the cabin of the truck during surveillance of the container 10.

FIG. 5 shows a second application scenario for the radio tag 12 and the reader 16 as related to rail transportation. In particular, FIG. 5 shows a first example where the reader 16 is attachably fixed along the rail line for short-range wireless communication to those containers located in the reach of the reader 16. The reader 16 may then achieve a short range communication with any or all of the radio tags 12 of the containers 10 that are transported on the rail line.

The same principles apply to a third application scenario for the container surveillance components, as shown in FIG. 6. Here, for each container to be identified, tracked, or monitored during sea transport, there must be provided a reader 16 in reach of the radio tag 12 attached to the container 10. A first option would be to modify the loading scheme according to the attachment schemes for the wireless communication units. Alternatively, the distribution of the readers 16 over the container ship could be determined in accordance with a loading scheme being determined according to other constraints and parameters. Again, the flexible attachment/detachment of readers 16 for the surveillance of containers allows to avoid any fixed assets that would not generate revenues for the operator. In other words, once no more surveillance of containers is necessary, the reader 16 may easily be detached from the container ship and either be used on a different container ship or any other transporting device. The reader 16 may also be connected to the AIS, based on VHF communication, or Inmarsat satellites, both often used by shipping vessels.

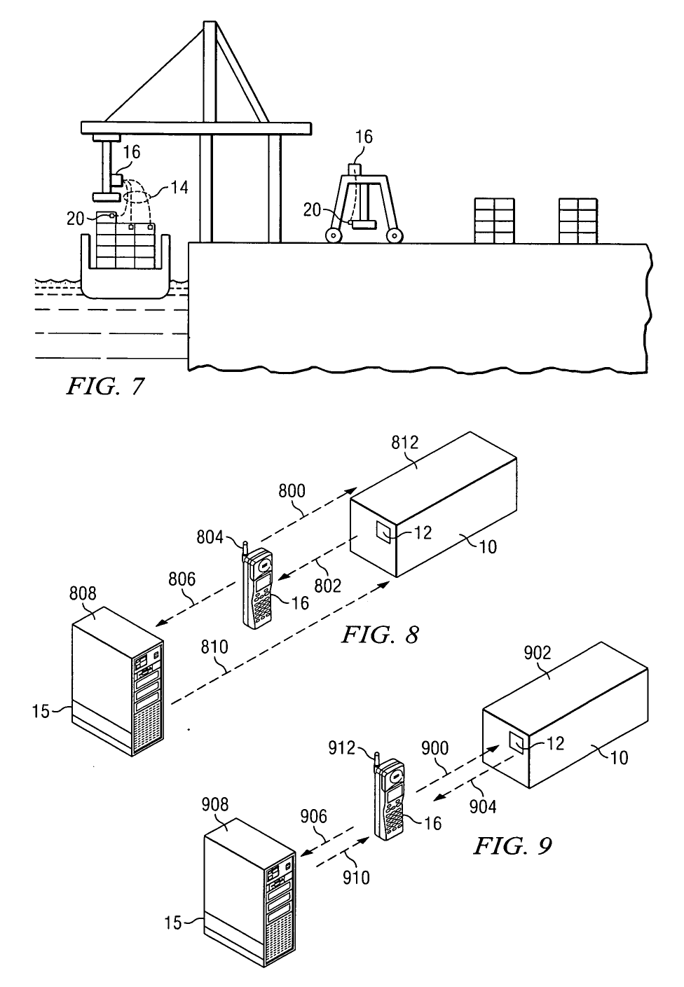

While above the application of the inventive surveillance components has been described with respect to long range global, regional or local transportation, in the following the application within a restricted area will be explained with respect to FIG. 7.

In particular, the splitting of the short range and long range wireless communication within a restricted area is applied to all vehicles and radio tags 12 handling the container 10 within the restricted area such as a container terminal, a container port, or a manufacturing site in any way. The restricted area includes in-gates and out-gates of such terminals and any kind of handling vehicles such as top-loaders, side-loaders, reach stackers, transtainers, hustlers, cranes, straddle carriers, etc.

A specific container is not typically searched for using only a single reader 16; rather, a plurality of readers 16 spread over the terminal and receive status and control information each time a container 10 is handled by, for example, a crane or a stacker. In other words, when a container passes a reader 16, the event is used to update related status and control information.

FIG. 8 illustrates a flow diagram of a securing process in accordance with principles of the present invention. First, at step 800, identification is requested from the radio tag 12 by the reader 16. At step 802, the radio tag 12 transmits the identification to the reader 16 and, at step 804, the reader 16 selects a container 10 to secure. A request is sent from the reader 16 to the server 15 at step 806. At step 808, the server 15 generates a security key and encrypts the security key with an encryption code. At step 810, the encrypted security key is transmitted to the radio tag 12 via the reader 16 in order to secure the container 10. At step 812, the security key is decrypted and stored in the radio tag 12. A similar procedure may be initiated to disarm the container 10. The container 10 may be secured automatically when passing in range of a reader 16, or a user may secure or disarm specific chosen containers 10 at a time.

FIG. 9 illustrates a security-check process in accordance with principles of the present invention. At step 900, the reader 16 transmits a challenge to the container 10 in question. At step 902, the radio tag 12 of the container 10 generates a response using a security key and an encryption code. At step 904, the response is sent from the radio tag 12 to the reader 16. At step 906, the reader 16 also sends a challenge to the server 15. The challenges to the server 15 and the radio tag 12 may be transmitted substantially simultaneously or at alternate points in time. The server 15 generates and sends a response utilizing the security key and an encryption code to the reader 16 at steps 908 and 910 respectively. At step 912, the reader 16 determines if the responses are equal. If the responses are equal, then the container 10 remains safely secured. Alternatively, if the responses are not equal, then a security breach (i.e., door event) of the container 10 has occurred. Similarly to the securing and disarming processes, a security-check may be performed automatically as the container 10 passes in range of a reader 16 or a user may initiate a security-check at any time during transport.

When using radio tags, for example, for asset management or security purposes, the radio tags often need to be read by readers mounted in buildings, on gates, in industrial areas, etc. The distance at which a particular reader can read a radio tag is often smaller than an area that needs to be covered. As a consequence, a plurality of readers may need to be located in a limited area. For example, in a system intended to monitor freight containers with readers at port gates, typically up to twenty truck lanes may be required to be monitored, which usually cannot be accomplished with one reader. As a result, a plurality of readers will need to be used. If two or more of these readers are transmitting signals at the same time, the transmitting readers may interfere with one another and thereby limit the readability of the radio tags.

As noted above, in order to save power, the radio tags may spend a significant part of their operation time in a sleep mode. In order to read a radio tag, the reader needs to send a wakeup signal to the radio tag in order to instruct the radio tag to wake-up from the sleep mode. The wakeup signal needs to last long enough to make sure that the radio tag has been able to receive it. The wakeup signal is typically continuously transmitted by the reader for a predetermined period of time. Thus, the radio tag is aware of when the wakeup signal ends (i.e., the wakeup signal end time). By knowing the wakeup signal end time, the radio tag knows when it may respond to the wakeup signal.

If several readers are continuously sending the wakeup signals in order to read the radio tags, there is an increased risk that a particular reader will send a wakeup signal when another reader is listening for an answer signal from the radio tags. As a result, the reader may not receive the answer signal due to signal interference. For example, if a first reader is broadcasting wakeup signals to radio tags close to the reader at the same time a second reader is listening for answer signals from the radio tags, the wake up signals and/or answer signals from the radio tags could be blocked due to signal interference. If many readers are mounted in a limited area, the probability that a given reader can read a radio tag can be significantly reduced due to interference.

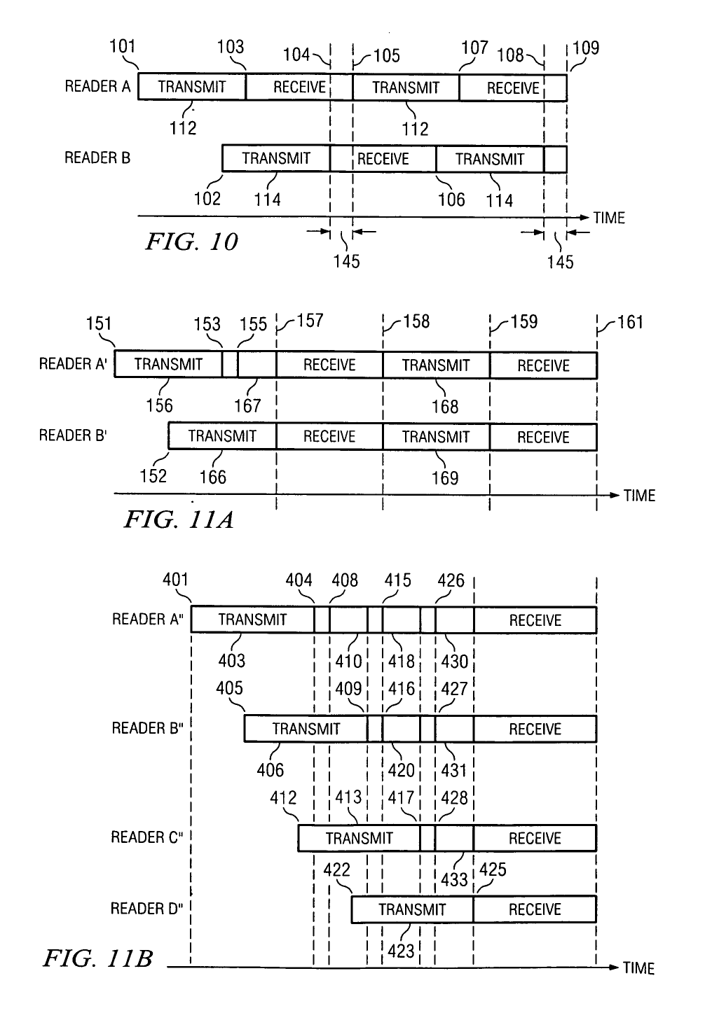

Referring to FIG. 10, a diagram illustrating operation of a typical system without synchronization of wakeup signals between readers is shown. In FIG. 10, a Reader A begins transmitting a wakeup signal 112 at a time 101 and continues to transmit the wakeup signal 112 for a predetermined duration. At the end of the transmission of the wakeup signal 112, the Reader A enters a receive mode at a time 103, in which the Reader A monitors for reception of an answer signal from one or more radio tags for a predetermined duration ending at a time 105. At time 105, the Reader A transmits another wakeup signal 112 for a predetermined duration ending at a time 107, after which the Reader A again enters the receive mode to listen for an answer signal from one or more radio tags for a duration ending at a time 109.

After the Reader A has begun transmitting the wakeup signal 112 at time 101, but before the wakeup signal 112 transmission has ended at time 103, a Reader B turns on at a time 102 and begins transmitting a wakeup signal 114 for a predetermined duration. After transmission of the wakeup signal 114 has ended, the Reader B enters a receive mode beginning at a time 104, during which the Reader B monitors for the reception of an answer signal from one or more radio tags. At time 106, the Reader B may again transmit a wakeup signal 114 for a duration ending at a time 108.

As can be seen in FIG. 10, a portion of the Reader B's wakeup signal 114 overlaps the receive mode of Reader A, potentially resulting in interference between the wakeup signal 114 of Reader B and the answer signal of one or more radio tags transmitted during the receive mode of the Reader A. As a result, the one or more radio tags only have a relatively small non-overlapping time window 145 during which to reply to a wakeup signal 112, 114 from either Reader A or Reader B without encountering interference.

In order to minimize this intra-system interference, it is desirable to synchronize the wakeup signals transmitted from the readers to the radio tags in a given area so that the wakeup signals are transmitted at approximately the same time. In accordance with principles of the present invention, the readers align their wakeup signals to approximately the same time by monitoring for transmission of wakeup signals from other readers.

Referring now to FIG. 11A, a diagram illustrating operation of a system with synchronization of wakeup signals between readers in accordance with principles of the present invention is shown. In accordance with a typical embodiment of the invention, when a Reader A′ is listening for an answer signal from one or more radio tags in response to a previously-sent wakeup signal, the Reader A′ also monitors for wakeup signals from a Reader B′. If the Reader A′ detects a wakeup signal from the Reader B′, the Reader A′ can align its next wakeup signal so that both the Reader A′ and the Reader B′ transmit their wakeup signals at approximately the same time. Those having skill in the art will appreciate that this process may be readily extended to work with systems having more than two readers.

Still referring to FIG. 11A, the Reader A′ begins transmitting a wakeup signal 156 at a time 151 and continues to transmit the wakeup signal for a predetermined duration ending at a time 153, after which the Reader A′ enters a receive mode. While the Reader A′ is transmitting the wakeup signal 156, the Reader B′ turns on at a time 152 and begins transmitting a wakeup signal 166 for a predetermined duration ending at a time 157. The Reader A′ detects the wakeup signal 166 transmitted by the Reader B′ during the receive mode after time 153. The time 157 at which the wakeup signal 166 transmitted by Reader B′ will end may be determined from information in the wakeup signal 166. In some embodiments, the time at which the wakeup signal 166 will end could be set to a pre-defined value.

Responsive to detecting the wakeup signal 166 and determining the end time 157 of the wakeup signal 166 transmitted by the Reader B′, the Reader A′ transmits a wakeup signal 167 beginning at a time 155 and continuing for a duration extending to the end time 157 of the wakeup signal 166 of the Reader B′. In a typical embodiment of the present invention, the time at which the wakeup signal 166 transmitted by the Reader B′ will end is included as data in the wakeup signal 166. However, those having skill in the art will appreciate that data from which the Reader A′ could determine the end time of the transmission of the Reader B′ need not be in this particular form and could take numerous other forms without departing from principles of the invention.

At the end of the transmission of wakeup signal 166 of the Reader B′ and the wakeup signal 167 of the Reader A′, receive and transmit windows of Reader A′ and Reader B′ are approximately synchronized in time. The Reader A′ and the Reader B′ both enter respective receive modes at substantially the same time 157, the receive modes having approximately the same duration and ending at a time 158.

The Reader A′ and the Reader B′ then transmit subsequent wakeup signals 168, 169 at approximately the same time 158 for approximately the same duration ending at a time 159. The Reader A′ and the Reader B′ then enter their respective receive modes at approximately the same time 159 for approximately the same duration ending at a time 161. Thus, the transmit and receive windows of the Reader A′ and the Reader B′ remain substantially synchronized, resulting in minimal intra-system interference between the Reader A′, the Reader B′, and one or more radio tags.

Referring now to FIG. 11B, a diagram illustrating operation of a system with synchronization of wakeup signals between readers in accordance with principles of the present invention is shown. In the system of FIG. 11B, four readers operate to synchronize their respective wakeup signals. A Reader A″ begins transmitting a wakeup signal 403 at a time 401 and continues to transmit the wakeup signal 403 for a predetermined duration ending at a time 404. While the Reader A″ is transmitting the wakeup signal 403, a Reader B″ turns on at a time 405 and begins transmitting a wakeup signal 406 for a duration ending at a time 409. The Reader A″ detects the wakeup signal 406 transmitted by the Reader B″ during a receive mode after the time 404. The time 409 at which the wakeup signal 406 transmitted by Reader B″ may be determined from information in the wakeup signal 406. In some embodiments, the time at which the wakeup signal 406 will end could be set to a pre-defined value.

Responsive to detecting the wakeup signal 406 and determining the end time 409 of the wakeup signal 406 transmitted by Reader B″, the Reader A″ beings to transmit a wakeup signal 410 at a time 408 and continues to transmit the wakeup signal 410 for a duration extending to the end time 409 of the wakeup signal 406 of the Reader B″. In a typical embodiment of the present invention, the time 409 at which the wakeup signal 406 transmitted by the Reader B″ ends is included as data in the wakeup signal 406.

While the Reader B″ is transmitting the wakeup signal 406, a Reader C″ begins transmitting a wakeup signal 413 at a time 412 and continue to transmit the wakeup signal 413 for a predetermined duration ending at a time 417. The Reader A″ and the Reader B″ detect the wakeup signal 413 transmitted by the Reader C″ during their respective receive modes. Responsive to detecting the wakeup signal 413 and determining the end time 417 of the wakeup signal 413 transmitted by Reader C′, the Reader A″ begins to transmit a wakeup signal 418 at a time 415 having a duration extending to the end time 417 of the wakeup signal 413 of the Reader C″. Also responsive to detecting the wakeup signal 413 and determining the end time 417 of the wakeup signal 413 transmitted by the Reader C″, the Reader B″ transmits a wakeup signal 420 beginning at a time 416 for a duration extending to the end time 417 of the wakeup signal 413 of the Reader C″.

While the Reader C″ is transmitting the wakeup signal 413, a Reader D″ begins transmitting a wakeup signal 423 at a time 422 and continues transmitting the wakeup signal 423 for a predetermined duration having an end time 425. The Reader A″, Reader B″, and Reader C″ detect the wakeup signal 423 transmitted by the Reader D′. Responsive to detecting the wakeup signal 423 and determining the end time 425 of the wakeup signal 423 transmitted by Reader D″, the Reader A″ transmits a wakeup signal 430 beginning at a time 426 for a duration extending to the end time 425 of the wakeup signal 423 of the Reader D″. Also responsive to detecting the wakeup signal 413 and determining the end time 425 of the wakeup signal 423 transmitted by Reader D″, the Reader B″ begins to transmit a wakeup signal 431 at a time 427 for a duration extending to the end time 425 of the wakeup signal 423 of the Reader D″. Further responsive to detecting the wakeup signal 423 and determining the end time 425 of the wakeup signal 423 transmitted by Reader D″, the Reader C″ begins to transmit a wakeup signal 433 at a time 428 for a duration extending to the end time 425 of the wakeup signal 423 of the Reader D″.

At the end of the transmission of the wakeup signal 430 by the Reader A″, the wakeup signal 431 by the Reader B″, the wakeup signal 433 by the Reader C″, and the wakeup signal 423 by the Reader D″, the receive and transmit windows of Reader A″, Reader B″, Reader C″, and Reader D″ are approximately synchronized in time. The Reader A″, Reader B″, Reader C″ and Reader D″ enter respective receive modes at substantially the same time 425, the receive modes having approximately the same duration. Thereafter, the transmit and receive windows of the Reader A″, the Reader B″, the Reader C″ and the Reader D″ remain substantially synchronized, resulting in minimal intra-system interference between the Reader A″, the Reader B″, the Reader C″, the Reader D″, and one or more radio tags.

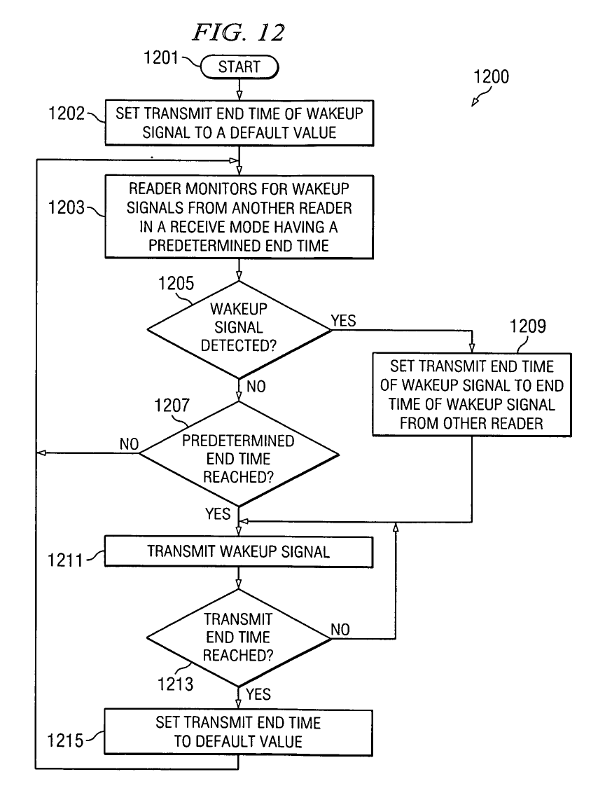

Referring now to FIG. 12, a process for synchronization of wake-up signals of a reader with those of one or more other readers is illustrated. A process flow 1200 begins at a step 1201. At a step 1202, a wakeup signal transmit end time for a Reader is set to a default value. At a step 1203, the Reader monitors for the presence of a wakeup signal from another Reader in a receive mode having a predetermined end time. At a step 1205, the Reader makes a determination regarding whether a wakeup signal from another Reader is detected. If a wakeup signal from another Reader is not detected, the process continues to a step 1207. In step 1207, a determination is made regarding whether the predetermined end time of the receive mode of the Reader has been reached. If the predetermined end time of the receive mode has not been reached, the process returns to the step 1203. If the predetermined end time of the receive mode has been reached, the process continues to step 1211. In step 1211, the Reader begins transmitting a wakeup signal having an end time equal to the default value.

If in a step 1205, a wakeup signal from another Reader is detected, the process continues to step 1209. In a step 1209, the Reader sets the transmit end time of the wakeup signal of Reader to a new time equal to the end time of the wakeup signal from the other reader. The process then continues to the step 1211, in which the Reader begins transmitting a wakeup signal having an end time equal to that of the new value. In a step 1213, a determination is made regarding whether the transmit end time of the wakeup signal has been reached. If the transmit end time has not been reached, the process returns to step 1211. If the transmit end time has been reached, the process continues to step 1215, in which the transmit end time of wakeup signals is set to the default value. At the end of the process 1200, the wakeup signals of the Reader is substantially synchronized with the wakeup signals of the other readers.

In still other embodiments, the Reader may measure the signal strength of wakeup signals received from other readers, and use a signal strength threshold to disregard signals from readers having wakeup signals that are determined to be too weak to interfere with signals transmitted by the Reader or received from an electronic tag.

Although various described embodiments are directed to readers operating in half-duplex fashion (i.e., having separate non-overlapping transmit and receive modes), those having skill in the art will recognize that principles of the invention could be applied to readers that operate in full-duplex fashion, in which the readers transmit and receive simultaneously. In such cases, the reader does not need to enter a receive mode in order to detect wakeup signals from another reader or response signals from one or more radio tags.

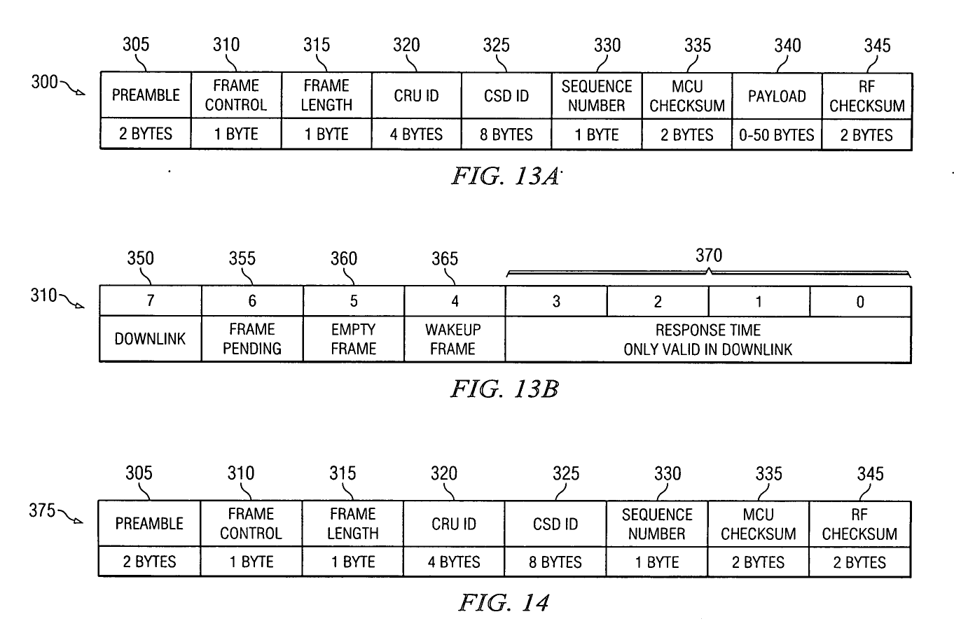

Referring now to FIGS. 13A-13B, a data format for exchanging messages between a reader, also referred to as a container reader unit (CRU), and an radio tag, also referred to as a container security device (CSD) in accordance with principles of the present invention is illustrated. In the presently described embodiment, the reader unit transmits two different types of messages, a wake-up message, and a response/request message. The wake-up data frame is transmitted by the reader unit to one or more radio tags in order to instruct the radio tags to wake up their transmitters in order to response to a subsequent request/response transmitted by the reader unit. The response/request message is used for message exchange between the reader unit and one or more radio tags. In the present embodiment, the message exchange is performed using a Carrier Sense Multiple Access/Collision Avoidance (CSMA-CA) transmission scheme, although it should be understood that other transmission schemes could be used. In accordance with the present embodiment, the response/request protocol is a nonbeacon enabled network protocol such as described in the IEEE 802.15.4 specification for Wireless Medium Access Control (MAC) and Physical Layer (PHY) Specifications for Low-Rate Wireless Personal Area Networks (LR-WPANs), incorporated herein by reference. The reader unit sends a data frame to acknowledge each data frame received from an radio tag, and the acknowledge data frame will contain the next part of the part of the data is there is data left in conjunction with the acknowledgement. If there is no more data to be sent, an empty acknowledgement is sent to inform the radio tag that the reader has received the response.

In order to save power and avoid unnecessary transmission, an radio tag will listen for a transmission from a reader unit at predetermined intervals, for example every 0.5 seconds on a wake-up channel. In accordance with the presently described embodiment, the responses from the radio tag are transmitted using unslotted CSMA-CA according to the IEEE 802.15.4 specification. After transmission of the response, the radio tag listens for acknowledgement during a specified time. If no acknowledgment has been received within the specified time, the response is retransmitted.

Referring to FIG. 13A, the data format 300 for exchanging messages between a reader and an radio tag includes a preamble portion 305, frame control portion 310, frame length portion 315, CRU ID portion 320, CSD ID portion 325, sequence number portion 330, MCU checksum portion 335, payload portion 340, and RF checksum portion 345. The preamble portion 305 is a two-byte identifier used to distinguish between different radio networks. The frame control portion 310 is further described with respect to FIG. 13B.

Referring now to FIG. 13B, the frame control portion 310 includes a downlink bit 350, frame pending bit 355, empty frame bit 360, wake-up frame bit 365, and response time portion 370. The downlink bit 350 is set to a value of 0 for a frame sent from an radio tag to a reader unit, and is set to a value of 1 for a frame sent from a reader unit to an radio tag. The frame pending bit 355 is set to a value of 0 if no more data is pending, and is set to a value of 1 if more data will be sent in the next frame. The empty frame bit 360 is set to a value of 0 for a normal frame with a payload, and is set to a value of 1 if no payload is included in the frame. The wake-up frame bit 365 is set to a value of 0 if the frame is a normal frame, and is set to a value of 1 for a wake-up request frame. The response time portion 370 is a 4-bit value that defines the earliest time in 50 ms when the radio tag will respond, the time being calculated from when the radio tag has received the preamble of the request.

Referring again to FIG. 13A, the frame length portion 315 specifies the total number of octets contained in the frame including the frame length portion 315, but excluding the preamble portion 305 and the RF checksum portion 345. The CRU ID portion 320 includes a 32-bit address of the reader unit. The CSD ID portion 325 includes a 64-bit address of the radio tag. The sequence number portion 330 is a 8-bit field that specifies a unique sequence for each frame. The radio tag will answer with the same sequence number as received in the corresponding frame from the reader unit. The MCU checksum portion 335 is a checksum of the frame content from frame length to source address including all of the bytes in the payload. In accordance with principles of the present invention, the checksum is calculated as a 16-bit CRC-CCITT checksum. The payload portion 340 is of a variable length and contains the information payload of the frame. The RF checksum portion 345 is a 16-bit cyclic redundancy check (CRC) added by the RF hardware.

Referring now to FIG. 14, a data format for a wakeup frame 375 in accordance with principles of the present invention is illustrated. The wakeup frame 375 is sent from a reader unit to an radio tag to instruct the radio tag to wakeup and send an acknowledgment. The wakeup frame 375 includes a preamble portion 305, frame control portion 310, frame length portion 315, CRU ID portion 320, CSD ID portion 325, sequence number portion 330, MCU checksum portion 335, and RF checksum portion 345. The wakeup-frame 375 does not contain a payload portion. The frame control portion 310 has the wakeup bit set to a value of 1 to indicate that the frame is a wakeup request frame. In response to receiving the wakeup frame 375 from the reader unit, the radio tag will send a response to the reader unit.

Those skilled in the art will appreciate that various embodiments of the invention may be implemented in computer software applications, programs, protocols, routines, and instructions (collectively “computer programming instructions”). The computer programming instructions typically are stored within memory of the system, and may be received or transmitted via a communications interface. When executed by a processor of a reader, the computer programming instructions enable the reader to perform various methods and processes in accordance with the principles of present invention.

It should be emphasized that the terms “comprise”, “comprises”, and “comprising”, when used herein, are taken to specify the presence of stated features integers, steps, or components, but do not preclude the presence or addition of one or more other features, integers, steps, components or groups thereof.

Although embodiment(s) of the present invention have been illustrated in the accompanying Drawings and described in the foregoing Detailed Description, it will be understood that the present invention is not limited to the embodiment(s) disclosed, but is capable of numerous rearrangements, modifications, and substitutions without departing from the invention defined by the following claims.

What is claimed is:

1. A method for synchronizing wakeup signals transmitted by a plurality of readers to at least one radio tag, the method comprising:
monitoring, by a first reader, for a first wakeup signal transmitted by a second reader; and
if the first wakeup signal is detected by the first reader, transmitting, by the first reader, a second wakeup signal having a duration ending at substantially the same time as the first wakeup signal.

2. The method of claim 1, wherein if the first wakeup signal is not detected by the first reader, transmitting, by the first reader of a third wakeup signal having a default duration.

3. The method of claim 1, wherein the first wakeup signal comprises information indicative of a time at which the first wakeup signal transmitted by the second reader will end.

4. The method of claim 1, further comprising at least one radio tag switching from a sleep mode to an active mode in response to receiving the first wakeup signal.

5. The method of claim 3, further comprising the at least one radio tag transmitting a response message to the second reader in response to receiving the first wakeup signal.

6. The method of claim 1, wherein the first reader enters a first receive mode and the second reader enters a second receive mode at substantially the same time.

7. The method of claim 6, wherein the first receive mode and the second receive mode have substantially the same duration.

8. The method of claim 1, wherein the first reader transmits a third wakeup signal and the second reader transmits a fourth wakeup signal at substantially the same time.

9. The method of claim 1, wherein the first wakeup signal is transmitted using a Carrier Sense Multiple Access/Collision Avoidance (CSMA/CA) transmission scheme.

10. The method of claim 1, wherein the at least one radio tag is adapted for attachment to a container.

11. The method of claim 1, wherein the first reader comprises at least one of a handheld reader, a mobile reader, and a fixed reader.

12. A first reader for transmitting at least one wakeup signal to at least one radio tag, the first reader comprising:
at least one computer readable medium; and
processor instructions contained on the at least one computer readable medium, the processor instructions configured to be readable from the at least one computer readable medium by at least one processor and thereby cause the at least one processor to operate as to:
monitor for a first wakeup signal transmitted by a second reader; and
if the first wakeup signal is detected, transmit a second wakeup signal having a duration ending at substantially the same time as the first wakeup signal.

13. The first reader for transmitting at least one wakeup signal to at least one radio tag of claim 12, wherein the processor instructions are further configured to cause the at least one processor to operate as to transmit a third wakeup signal having a default duration if the first wakeup signal is not detected by the first reader.

14. The first reader for transmitting at least one wakeup signal to at least one radio tag of claim 12, wherein the first wakeup signal comprises information indicative of a time at which the first wakeup signal transmitted by the second reader will end.

15. The first reader for transmitting at least one wakeup signal to at least one radio tag of claim 12, wherein the first wakeup signal instructs the at least one radio tag to switch from a sleep mode to an active mode.

16. The first reader for transmitting at least one wakeup signal to at least one radio tag of claim 12, wherein the first wakeup signal instructs the at least one radio tag to transmit a response message to the second reader in response to receiving the first wakeup signal.

17. The first reader for transmitting at least one wakeup signal to at least one radio tag of claim 12, wherein the processor instructions are further configured to cause the at least one processor to operate such that the first readers enters a first receive mode at substantially the same time as the second reader enters a second receive mode.

18. The first reader for transmitting at least one wakeup signal to at least one radio tag of claim 17, wherein the first receive mode and the second receive mode have substantially the same duration.

19. The first reader for transmitting at least one wakeup signal to at least one radio tag of claim 12, wherein the processor instructions are further configured to cause the at least one processor to operate such that the first reader transmits a third wakeup signal at substantially the same time as the second reader transmits a fourth wakeup signal.

20. The first reader for transmitting at least one wakeup signal to at least one radio tag of claim 12, wherein the first reader comprises at least one of a handheld reader, a mobile reader, and a fixed reader.
